(19) United States
(12) Patent Application Publication
(10) Pub. No.: US 2010/0049540 A1
(43) Pub. Date: Feb. 25, 2010

(54) CONTENT DELIVERY APPARATUS, CONTENT REPRODUCING APPARATUS, CONTENT DELIVERY METHOD, CONTENT REPRODUCING METHOD, CONTENT DELIVERY PROGRAM, CONTENT REPRODUCING PROGRAM, AND RECORDING MEDIUM

(75) Inventor: Hiroaki Shibasaki, Tokyo (JP)

Correspondence Address: YOUNG & THOMPSON, 209 Madison Street, Suite 500, Alexandria, VA, 22314, US

(73) Assignee: PIONEER CORPORATION, Tokyo (JP)

(21) Appl. No.: 12/515,838

(22) PCT Filed: Dec. 8, 2006
(86) PCT No.: PCT/JP2006/324544

§ 371 Date: May 21, 2009

(51) Int. Cl. G06F 21/00; G06Q 30/00; G06F 21/24

(52) U.S. Cl. 705/1.1; 726/26

(57) ABSTRACT

A content delivery apparatus delivers, to an information processing device, content data reproducible within an effective period. The content delivery apparatus includes a payment information acquiring unit that acquires information concerning a state of payment that is from a user of the information processing device and for a fee for delivery of the content data; a temporary authentication information sending unit that sends, to the user without using a communication line, temporary authentication information to temporarily extend the effective period, when the information acquired by the payment information acquiring unit indicates that the payment of the fee has been made; and a formal authentication information sending unit that sends, to the information processing device by using the communication line, formal authentication information to formally extend the effective period, when the information acquired by the payment information acquiring unit indicates that the payment of the fee has been made.

### TECHNICAL FIELD

The present invention relates to a content delivery apparatus, a content delivery method, a content delivery program, and a recording medium that deliver predetermined content data. The present invention further relates to a content reproducing apparatus, a content reproducing program, and a recording medium that reproduce predetermined content data. Utilization of the present invention, however, is not limited to the content delivery apparatus, the content reproducing apparatus, the content delivery method, the content reproducing method, the content delivery program, the content reproducing program, and the recording medium.

### BACKGROUND ART

In recent years, a service called subscription service is gaining widespread use and enables a user to download and watch and hear (listen to) desired content data from among a group of content data such as music, etc., for a period limited by a contract term, at a predetermined contract fee. The subscription service adopts, for example, a download system of copying the content data to the content reproducing apparatus of the user or a streaming system in which the content data does not remain on the content reproducing apparatus of the user. The subscription service enables the user to watch and listen to a large amount of content at a low contract fee.

A technology is proposed for smoothing distribution of content data in the subscription service. For example, a content server encrypts content when providing the content to a client by way of the Internet. A header of the encrypted content includes description of attribute information of the content. The subscriber obtains a license permitting reproduction of the encrypted content by accessing a license server to obtain a license whose attribute conditions the attribute information of the content satisfies (see, e.g., patent document 1).

Patent Document 1: Japanese Patent Application Laid-Open Publication No. 2005-346731

### DISCLOSURE OF INVENTION

### Problem to be Solved by the Invention

With respect to the above technology, however, a problem arises in that, for example, the content data can no longer be used when the license of the content data expires. For example, with respect to a contract scheme where the license is renewed by way of a network, in an environment where the network cannot be accessed, since the license cannot be renewed, the content data can no longer be used.

For example, when a user does not use a content reproducing apparatus and has not turned on the power source thereof for several days, the content reproducing apparatus cannot connect to the network and cannot renew the license. Further, the license cannot be renewed when the content reproducing apparatus is a mobile terminal (such as a cellular phone terminal and a navigation device) located in an area where the network is not available.

In such cases if the content data immediately becomes unusable, the convenience of the subscription service decreases as compared with, for example, the purchase of the content data. As a result, for example, a problem arises in that it becomes difficult for the subscription service to obtain support from the user.

### Means for Solving Problem

A content delivery apparatus according to the invention of claim 1 delivers, to an information processing device, content data reproducible within a given effective period. The content delivery apparatus includes a payment information acquiring unit that acquires information concerning a state of payment that is from a user of the information processing device and for a fee for delivery of the content data; a temporary authentication information sending unit that sends, to the user without using a communication line, temporary authentication information to temporarily extend the effective period, when the information acquired by the payment information acquiring unit indicates that the payment of the fee has been made; and a formal authentication information sending unit that sends, to the information processing device by using the communication line, formal authentication information to formally extend the effective period, when the information acquired by the payment information acquiring unit indicates that the payment of the fee has been made.

A content reproducing apparatus according to the invention of claim 2 reproduces content data reproducible within a given effective period. The content reproducing apparatus includes a formal authentication information acquiring unit that acquires, by using a communication line and from a content delivery apparatus that delivers the content data, formal authentication information to extend the effective period; an input unit that receives input of an instruction to reproduce the content data; a determining unit that determines whether a date-time on which the input unit has received the instruction to reproduce is within the effective period based on the formal authentication information acquired by the formal authentication information acquiring unit; a reproducing unit that reproduces the content data when the determining unit determines that the date-time is within the effective period based on the formal authentication information; and a temporary authentication information acquiring unit that acquires temporary authentication information to temporarily extend the effective period without using a communication line when the determining unit determines that the date-time is not within the effective period based on the formal authentication information. The determining unit determines whether the date-time on which the input unit has received the instruction to reproduce is within the effective period based on the temporary authentication information acquired by the temporary authentication information acquiring unit. The reproducing unit reproduces the content data when the determining unit determines that the date-time is within the effective period based on the temporary authentication information.

A content delivery method according to the invention of claim 4 is a method of delivering, to an information processing device, content data reproducible within a given effective period. The content delivery method includes a payment information acquiring step of acquiring information concerning a state of payment that is from a user of the information processing device and for a fee for delivery of the content data; a temporary authentication information sending step of sending, to the user without using a communication line, temporary authentication information to temporarily extend the effective period, when the information acquired at the payment information acquiring step indicates that the payment of the fee has been made; and a formal authentication information sending step of sending, to the information processing device by using the communication line, formal authentication information to formally extend the effective period, when the information acquired at the payment information acquiring step indicates that the payment of the fee has been made.

A content reproducing method according to the invention of claim 5 is a method of reproducing content data reproducible within a given effective period. The content reproducing method includes a formal authentication information acquiring step of acquiring, by using a communication line and from a content delivery apparatus that delivers the content data, formal authentication information to extend the effective period; an input step of receiving input of an instruction to reproduce the content data; a first determining step of determining whether a date-time at which the input step has received the instruction to reproduce is within the effective period based on the formal authentication information acquired at the formal authentication information acquiring step; a first reproducing step of reproducing the content data when at the first determining step it is determined that the date-time is within the effective period based on the formal authentication information; a temporary authentication information acquiring step of acquiring temporary authentication information to temporarily extend the effective period without using a communication line when at the first determining step it is determined that the date-time is not within the effective period based on the formal authentication information; a second determining step of determining whether the date-time at which the input step has received the instruction to reproduce is within the effective period based on the temporary authentication information acquired at the temporary authentication information acquiring step; and a second reproducing step of reproducing the content data when at the second determining step it is determined that the date-time is within the effective period based on the temporary authentication information.

A content delivery program according to the invention of claim 6 causes a computer to execute the content delivery method according to claim 4.

A content reproduction program according to the invention of claim 7 causes a computer to execute the content reproduction method according to claim 5.

A computer-readable recording medium according to the invention of claim 8 stores therein the content delivery program according to claim 6 or the content reproduction program according to claim 7.

### BRIEF DESCRIPTION OF DRAWINGS

FIG. 1 is a block diagram of a functional configuration of a content delivery system;

FIG. 2 is a flowchart of a procedure of the content delivery processing by a content delivery apparatus;

FIG. 3 is a flowchart of a procedure of content reproduction processing by a content reproducing apparatus;

FIG. 4 is a diagram depicting an overview of a music delivery system;

FIG. 5 is a diagram for description of one example of music delivery by the music delivery system;

FIG. 6 is a block diagram of one example of a hardware configuration of a subscription service server;

FIG. 7 is a block diagram of one example of a hardware configuration of a navigation device;

FIG. 8 is a flowchart of a procedure of effective period renewal processing by the subscription service server; and

FIG. 9 is a flowchart of a procedure of the content reproduction processing by the content reproducing apparatus.

### EXPLANATIONS OF LETTERS OR NUMERALS

100 content delivery system

110 content delivery apparatus

111 payment information acquiring unit

112 temporary authentication information sending unit

113 formal authentication information sending unit

120 content reproducing apparatus

121 formal authentication information acquiring unit

122 input unit

123 determining unit

124 reproducing unit

125 temporary authentication information acquiring unit

126 authenticating unit

130 communication line

140 user

### BEST MODE(S) FOR CARRYING OUT THE INVENTION

A preferred embodiment will now be described in detail of a content delivery apparatus, a content reproducing apparatus, a content delivery method, a content reproducing method, a content delivery program, a content reproducing program, and a recording medium according the present invention with reference to the accompanying drawings.

### Embodiment

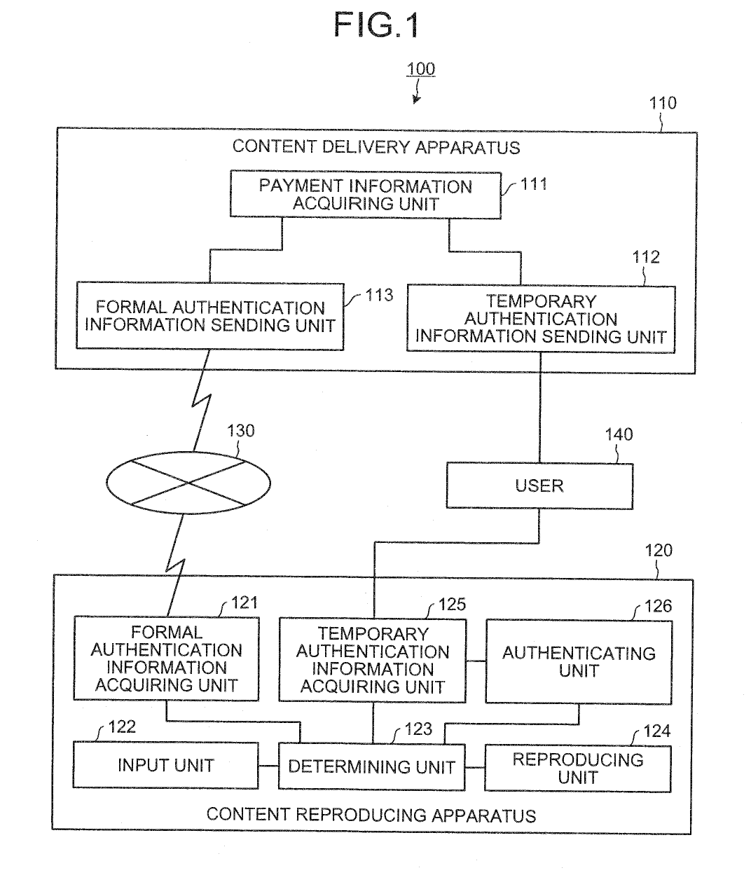

Functional configuration will be described of a content delivery system 100 according to the embodiment of the present invention. FIG. 1 is a block diagram of a functional configuration of the content delivery system. As depicted in FIG. 1, a content delivery system 100 comprises a content delivery apparatus 110 and a content reproducing apparatus 120. A “user” as used in the following description means the user of the content reproducing apparatus 120.

The content delivery apparatus 110, including a payment information acquiring unit 111, a temporary authentication information sending unit 112, and a formal authentication information sending unit 113, delivers to an information processing device (e.g., the content reproducing apparatus 120, etc.), content data that can be reproduced for a predetermined effective period. The content delivery apparatus 110 is a group of servers under the control of a content distributor that provides, for example, a subscription service. The subscription service is, for example, a service enabling a user 140 to download content data from among a predetermined group of content and reproduce downloaded content data using the content reproducing apparatus 120, etc., of the user 140 for a period limited by a contract term at a predetermined contract fee.

While, generally, the subscription service includes a service of providing the content by streaming reproduction as well, the present specification describes a scheme to realize a service that permits the user 140 to download the content data of the predetermined group of content data or reproduce the downloaded content data during the contract term by paying the predetermined contract fee, as described above.

The content data delivered by the content delivery apparatus 110 includes various data such as, for example, video data, music data, image data, and application data. The content data may be delivered by use of a communication line 130 or by, for example, postal mailing of a recording medium storing therein the content data.

The content data delivered by the content delivery apparatus 110 can be reproduced only within a predetermined effective period. The effective period of the content data is established according to the fee paid for delivery of the content data. For example, when a given amount has been paid by the user 140 of the content reproducing apparatus 120, the effective period is established based on the paid amount.

The payment information acquiring unit 111 acquires information concerning the state of the payment, by the user 140 of the content reproducing apparatus 120, of the fee for the delivery of the content data. The payment information acquiring unit 111 acquires information indicating whether a usage charge for the subscription service has been paid by the user 140, based on, for example, the information concerning a monthly charge, an annual charge, etc., for the subscription service, information concerning the term of the contract with the user 140, and information concerning payment made to a bank account of the content distributor.

The temporary authentication information sending unit 112 sends, to the user 140 without using the communication line, temporary authentication information to temporarily extend the effective period when the payment information acquiring unit 111 acquires information indicating that the fee has been paid. The temporary authentication information sent to the user 140 is acquired by the content reproducing apparatus 120 through a temporary authentication information acquiring unit 125 to be described later.

The temporary authentication information sending unit 112 displays the temporary authentication information on a display unit of, for example, equipment used by the user 140 in making payment of the fee (such as a cash dispenser used in a bank-to-bank transfer, a POS terminal used in payment at a convenience store, and a cellular phone terminal device used in mobile banking). In this case, the user 140 causes the content reproducing apparatus 120 to acquire the temporary authentication information by inputting the temporary authentication information displayed on the display unit to the content reproducing apparatus 120.

The temporary authentication information sending unit 112 may also output the temporary authentication information to a receipt to be issued when the fee is paid by the user 140 or to a transfer-use IC card (such as a bank card and a credit card) utilized in making payment of the fee. In this case, the user 140 causes the content reproducing apparatus 120 to acquire the temporary authentication information by inputting the temporary authentication information output to the receipt, etc., to the content reproducing apparatus 120. The temporary authentication information sending unit 112 may also send a recording medium storing therein the temporary authentication information to the user 140. In this case, the user 140 causes the content reproducing apparatus 120 to acquire the temporary authentication information by causing the content reproducing apparatus 120 to read the temporary authentication information stored in the recording medium.

The temporary authentication information includes, for example, permit information permitting the reproduction of the content data only for a predetermined period and a program capable of executing the reproduction of the content data only for the predetermined period. The temporary authentication information is generated based on information that can be known commonly to the content delivery apparatus 110 and the content reproducing apparatus 120 even if the apparatuses are unable to communicate with each other by way of the communication line 130, such as, for example, identification information that identifies the content reproducing apparatus 120 or the user 140. The temporary authentication information is generated by a generating method (logic) that can be known only to the content delivery apparatus 110 and the content reproducing apparatus 120 and cannot be known to the user 140. Specifically, there are methods such as, for example, a method of rearranging a certain character string according to a predetermined logic and treating such rearranged string as the temporary authentication information.

As described, the content delivery apparatus 110 and the content reproducing apparatus 120 have in common the information from which the temporary authentication information is generated and the method of generation thereof. Thus, the content reproducing apparatus 120 can generate the same information as the temporary authentication information sent by the content delivery apparatus 120 and can confirm whether the temporary authentication information acquired by the content reproducing apparatus 120 has been officially issued.

The formal authentication information sending unit 113 sends formal authentication information to formally extend the effective period to the content reproducing apparatus 120 using the communication line 130 when the payment information acquiring unit 111 acquires the information indicating that the fee has been paid.

The reason will be described as to why the temporary authentication information sending unit 112 sends the temporary authentication information to the content reproducing apparatus 120. The extension of the effective period of the content data is performed by the formal authentication information being sent, by the formal authentication information sending unit 113, to the content reproducing apparatus 120 by way of the communication line 130. However, for example, when the content reproducing apparatus 120 is in a situation where the communication line 130 cannot be used, the effective period cannot be extended and the content data cannot be reproduced despite the fact that the payment of the fee has been made.

To prevent such a situation, the content delivery apparatus 110 sends, to the user 140, the temporary authentication information to temporarily extend the effective period of the content data upon confirming that the payment has been made by the user 140 of the content reproducing apparatus 120. The user 140 can temporarily extend the effective period using the temporary authentication information and reproduce the content data even if the content reproducing apparatus 120 cannot use the communication line 130 and cannot formally extend the effective period.

A functional configuration of the content reproducing apparatus 120 will be described. The content reproducing apparatus 120, including a formal authentication information acquiring unit 121, an input unit 122, a determining unit 123, a reproducing unit 124, a temporary authentication information acquiring unit 125, and an authenticating unit 126, reproduces the content data that is reproducible for the predetermined effective period and delivered by the content delivery apparatus 110.

The formal authentication information acquiring unit 121, using the communication line 130, acquires from the content delivery apparatus 110 that delivers the content data, the formal authentication information to extend the effective period. The formal authentication information acquiring unit 121 acquires the formal authentication information sent by, for example, the formal authentication information sending unit 113 of the content delivery apparatus 110.

The input unit 122 receives input of an instruction to reproduce the content data. The input unit 122 receives, for example, the input of the reproducing instruction given by the user 140. The input unit 122 is, for example, a reproducing instruction button provided on the content reproducing apparatus 120 or a reproducing instruction icon displayed on a display unit of the content reproducing apparatus 120 by the content reproducing program.

The determining unit 123 determines whether the date/time at which the input of the reproducing instruction is received by the input unit 122 is within the effective period, based on the formal authentication information acquired by the formal authentication information acquiring unit 121. When the formal authentication information has not been acquired by the formal authentication information acquiring unit 121, the determining unit 123 may determine whether the date/time is within the effective period set in the content data when delivered from the content delivery apparatus 110.

If it is determined by the determining unit 123 that the date/time is within the effective period based on the formal authentication information, then the reproducing unit 124 reproduces the content data.

If it is determined by the determining unit 123 that the date/time is not within the effective period based on the formal authentication information, the temporary authentication information acquiring unit 125 acquires the temporary authentication information to temporarily extend the effective period without using the communication line 130. The temporary authentication information acquiring unit 125 acquires the temporary authentication information by, for example, an input of the temporary authentication information by the user 140. The temporary authentication information acquiring unit 125 acquires the temporary authentication information by, for example, reading a recording medium storing therein the temporary authentication information.

The authenticating unit 126 authenticates whether the temporary authentication information acquired by the temporary authentication information acquiring unit 125 is the information sent by the content delivery apparatus 110. As described above, the content delivery apparatus 110 and the content reproducing apparatus 120 have in common the information from which the temporary authentication information is generated and the method of generation thereof. For this reason, the authenticating unit 126 can generate the same information as the temporary authentication sent by the content delivery apparatus 110 and can verify whether the temporary authentication information acquired by the temporary authentication information acquiring unit 125 is the information officially issued (sent) by the content delivery apparatus 110.

If the authenticating unit 216 authenticates that the temporary authentication information is the information acquired from the content delivery apparatus 110, the determining unit 123 determines whether the date/time at which the input of the reproducing instruction is received by the input unit 122 is within the effective period, based on the temporary authentication information acquired by the temporary authentication information acquiring unit 125. If it is determined by the determining unit 123 that the date/time is within the effective period based on the temporary authentication information, the reproducing unit 124 reproduces the content data.

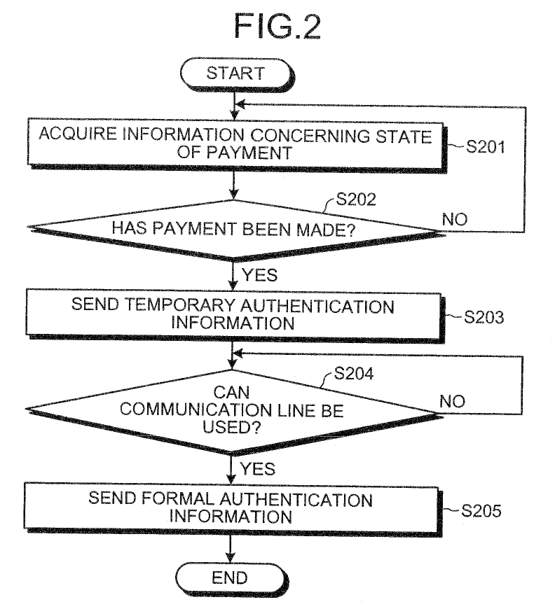

Processing of the content delivery apparatus 110 and the content reproducing apparatus 120 in the content delivery system 100 will be described. Content delivery processing by the content delivery apparatus 110 will be described first. FIG. 2 is a flowchart of a procedure of the content delivery processing by the content delivery apparatus. As depicted in the flowchart of FIG. 2, the content delivery apparatus 110, through the payment information acquiring unit 11, acquires the information concerning the state of the payment by the user 140 with respect to the fee for the delivery of the content data (step S201) and determines whether the fee has been paid for the delivery of the content data, based on the information concerning the payment state (step S202).

If the fee has been paid for the delivery of the content data (step S202: YES), then the content delivery apparatus 110, via the temporary authentication information sending unit 112, sends the temporary authentication information to the user 140 without using the communication line 130 (step S203). On the other hand, if the fee has not been paid (step S202: NO), the content delivery apparatus 110 returns to step S201 and repeats subsequent processing.

The content delivery apparatus 110 then determines whether the communication line 130 can be used (step S204). If the communication line 130 can be used (step S204: YES), then the content delivery apparatus 110, via the formal authentication information sending unit 113, sends the formal authentication information to the content reproducing apparatus 120 using the communication line 130 (step S205) and the processing according to the flowchart ends. On the other hand, if the communication line cannot be used (step S204: NO), the content delivery apparatus 110 waits until the communication line can be used (step 204: NO).

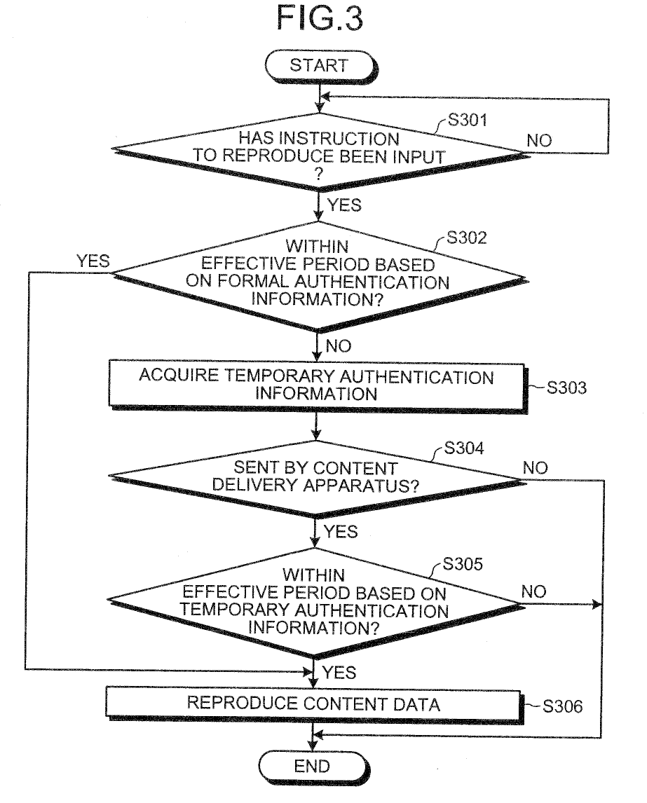

Content reproduction processing by the content reproducing apparatus 120 will be described. FIG. 3 is a flowchart of a procedure of the content reproduction processing by the content reproducing apparatus 120. As depicted in the flowchart of FIG. 3, the content reproducing apparatus 120 waits until the content data reproducing instruction is input to the input unit 122 (step S301: NO).

When the content data reproducing instruction is input (step S301: YES), the content reproducing apparatus 120, through the determining unit 123, determines whether the date/time at which the instruction is input at step S301 is within the effective period, based on the formal authentication information acquired by the formal authentication information acquiring unit 121 (step S302). Configuration may be such that if the formal authentication information acquiring unit 121 has not acquired the formal authentication information, the determining unit 123 will determine whether the date/time is within the effective period set in the content data when delivered by the content delivery apparatus 110.

If the date/time at which the instruction is input is within the effective period based on the formal authentication information (step S302: YES), the content reproducing apparatus 120 proceeds to the step S306. On the other hand, if the date/time at which the instruction is input is not within the effective period, based on the formal authentication information (step S302: NO), then the content reproducing apparatus 120, via the temporary authentication information acquiring unit 125, acquires the temporary authentication information without using the communication line 130 (step S303).

The content reproducing apparatus 120, via the authenticating unit 126, determines whether the temporary authentication information is the information sent by the content delivery apparatus 110 (step S304). If the temporary authentication information is the information sent by the content delivery apparatus 110 (step S304: YES), the determining unit 123 determines whether the date/time at which the instruction is input at step S301 is within the effective period, based on the temporary authentication information (step S305).

If the date/time is within the effective period based on the temporary authentication information (step S305: YES) or is within the effective period based on the formal authentication information at step S302 (step S302: YES), then the content reproducing apparatus 120, via the reproducing unit 124, reproduces the content data for which the reproduction is instructed (step S306) and the processing according to the flowchart ends.

On the other hand, if the date/time is not within the effective period based on the temporary authentication information at step S305 (step S305: NO) or if it is determined that the temporary authentication information is not the information sent by the content delivery apparatus 110 (step S304: NO), the processing according to the flowchart ends without reproduction of the content data.

As described above, the content delivery system 100 sends temporary authentication information to temporarily extend the effective period of the content data delivered to the user 140. Even if the content reproducing apparatus 120 cannot connect to the communication line 130 and cannot acquire the formal authentication information, the user 140 can temporarily extend the effective period and reproduce the content data by causing the temporary authentication information to be acquired by the content reproducing apparatus 120, thereby preventing an inability to reproduce the content data despite the payment of the fee for the delivery of the content data by the user 140 and enhancing the convenience of the content delivery system 100.

The content reproducing apparatus 120 determines whether the acquired temporary authentication information is the information officially issued by the content delivery apparatus 110, thereby enabling the content delivery system 100 to prevent fraudulent generation, etc. of the temporary authentication information by the user 140 and to ensure the fee for the delivery of the content data is obtained.

### Example

An example of the present invention will be described. The present example describes one example in which the content delivery apparatus of the present invention is implemented by a subscription service server providing the subscription service and the content reproducing apparatus of the present invention is implemented by a navigation device equipped on a vehicle, a PC (personal computer), a content player, etc.

### (Overview of System)

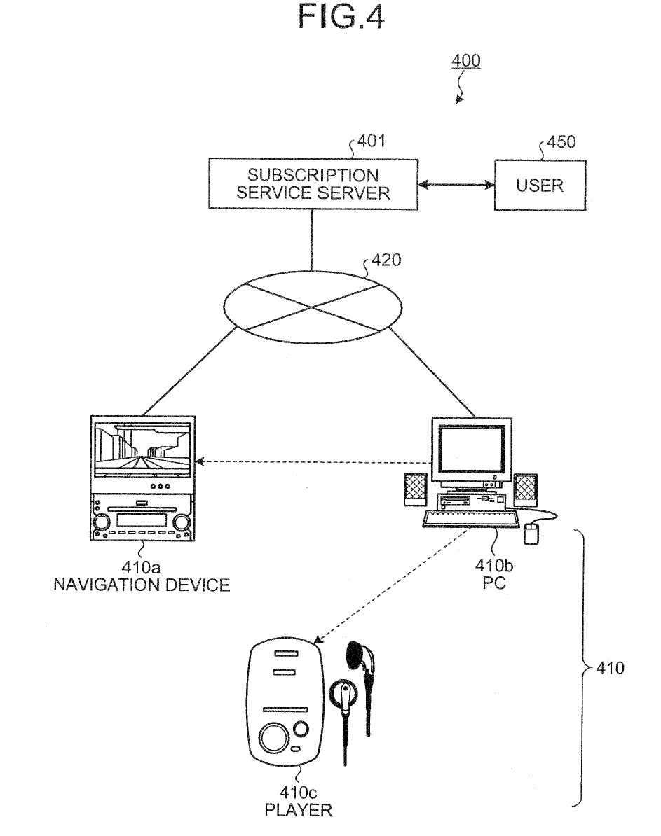

An overview of a music delivery system that distributes music as an example of the content delivery according to the present example will be described with reference to FIG. 4. FIG. 4 is a diagram depicting an overview of the music delivery system. As depicted in FIG. 4, a music delivery system 400 includes a subscription service server 401 and a content reproducing apparatus 410, specifically, for example, a navigation device 410a, a PC 410b, and a player 410c.

The subscription service server 401 and each content reproducing apparatus 410 are connected by way of a network 420. If, for example, the content reproducing apparatus 410 has no communication function, music data delivered to another content reproducing apparatus 410 can be copied to the content reproducing apparatus 410 using wired or wireless communication.

The subscription service server 401 delivers the music data to the content reproducing apparatus 410 of the user 450 under a music data delivery contract with the user 450 (subscription service contract). While the following description assumes that each content reproducing apparatus 410 is owned by the same user 450, the owners of the content reproducing apparatuses 410 may be different.

The subscription service server 401 may be a server group including, for example, a content server that keeps and manages the music data, an authenticating server that performs processing of authenticating a terminal of the user 450 and processing of setting and managing the effective period, etc., of the music data, and a charging server that manages contract information and charging information concerning the user 450. The server group is not limited to, for example, three servers and may include servers respectively having any one or more of the functions of the content server, the authenticating server, and the charging server, configured to realize all of the functions.

The navigation device 410a as an example of the content reproducing apparatus 410 is equipped on a mobile object such as a vehicle and, in addition to performing vehicular route guidance, reproduces the content recorded on a recording medium or acquired by a communication function. Specifically, the navigation device 410a is capable of reproducing the music data delivered by the subscription service server 401.

The PC 410b is equipped with various functions such as a document preparing function and an image processing function in addition to a function of reproducing the content data, the music data, etc. The PC 410b may be, for example, installed at the residence, work place, etc. of the user 450, or may be portable, e.g., a notebook PC.

The player 410c is a terminal device that reproduces content data such as music data delivered mainly by the subscription service server 401. The player 410c may be a device specialized in reproducing the content data including music data or may be a device having other functions as well like, for example, a cellular phone terminal device. The player 410c, in addition to receiving music data directly from the subscription service server 401, may further reproduce music data copied from the PC 410b or the navigation device 410a.

The content reproducing apparatus 410 such as the navigation device 410a, the PC 410b, and the player 410c has a function of referring to a list of or information concerning usable music data by a display unit, an audio output unit, etc., not depicted, and is capable of receiving a selection of the music data desired for listening by the user 450 through an operation unit, etc., and reproducing the music data.

The music data to be reproduced by the content reproducing apparatus 410 may be music data that is not downloaded from the subscription service server 401. Configuration may be such that the music to be reproduced is selected from among music kept and managed by, for example, the subscription service server 401 and upon completion of download, the selected music is reproduced.

When, for example, connection by one content reproducing apparatus 410 to the subscription service server 401 by way of the network 420 is unstable, configuration may be such that the music data will be delivered from the subscription service server 401 to another content reproducing apparatus owned by the user 450 and thereafter the music data is transferred to the content reproducing apparatus 410 having the unstable connection

### (One Example of Music Delivery)

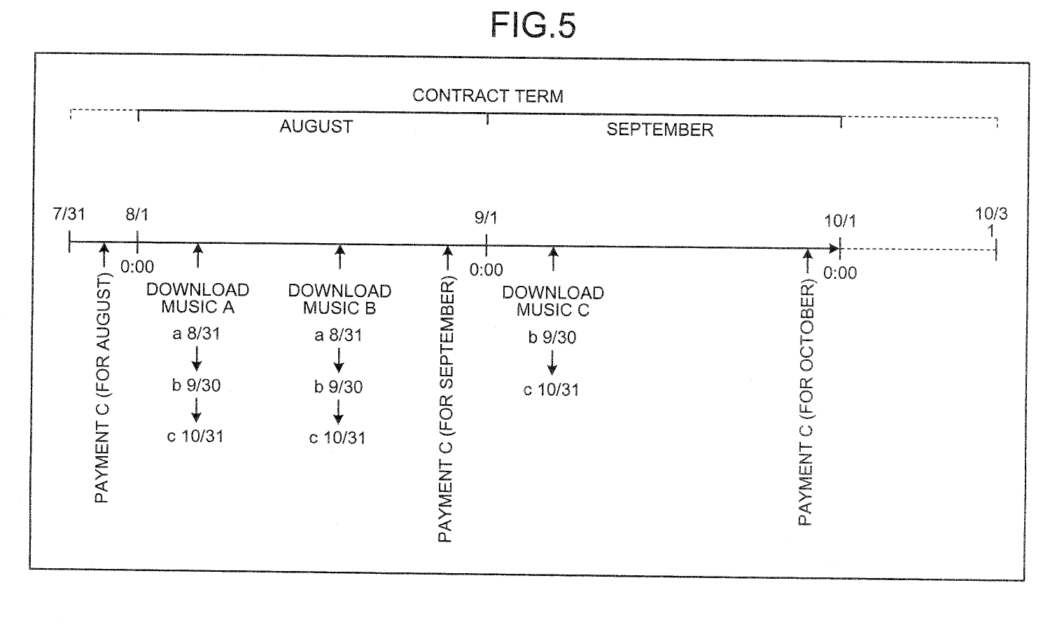

One example of music delivery by the music delivery system 400 will be described with reference to FIG. 5. FIG. 5 is a diagram for description of one example of music delivery by the music delivery system. FIG. 5 describes a method of payment according to a monthly charge that bills for one-month payment, each month. The method of payment according to the monthly charge is a method in which payment for the subsequent month of the subscription service contract is set by a time limit, for example, within the current month (e.g., 23 hours 59 minutes 59 seconds of the last day of the current month), as a deadline for payment and the subscription service contract is extended automatically for the next month.

FIG. 5 describes the subscription service where the contract period is predetermined, for example, for two months (August and September). The contract period may be predetermined at the time of a first payment or the contract may start when the payment is made and end when the monthly charge is no longer paid. As depicted in FIG. 5, the user 450 makes a subscription service contract with the subscription service server 401. In the example depicted in FIG. 5, the user 450 has made a contract for two months, August and September.

The subscription service server 401 accepts the subscription service having a predetermined contract period of two months. When the user 450 makes payment of the monthly charge for August having a payment deadline of July 31 (payment a), the subscription service server 401 generates subscriber information and charging information and starts the subscription service. The subscription service server 401 authorizes the downloading of contents by the user 450 until the end of August according to the prepared charging information.

The user 450, having made the payment a, may download during the period until August 31, the music data the user 450 likes, as much as the user 450 likes from the music data group prepared by the subscription service server 401. As depicted in FIG. 5, the user 450 downloads music data A and music data B. The subscription service server 401, upon receipt of a downloading request for the music data A or the music data B from the user 450, delivers the applicable music data A or music data B to the content reproducing apparatus 410 of the user 450.

At the time of delivering the music data, the subscription service server 401 sets the effective period for the music data, based on the charging information. The effective period is a period within which the content reproducing apparatus 410 of the user 450 is permitted to reproduce the music data. The effective period is set by effective period information being written, for example, in a predetermined position of the music data. In the example of FIG. 5, since only the payment a for August has been settled, the effective period set for the music data A and the music data B, i.e., the downloading of the content data is authorized by the payment a, continues until August 31 (to be more specific, August 31, 23 hours 59 minutes 59 seconds).

Upon receipt of an instruction to reproduce the content data, the content reproducing apparatus 410 refers to the effective period of the content data and determines whether the present time is within the effective period. The content reproducing apparatus 410 reproduces the content data if the present time is within the effective period of the content data and does not reproduce the content data if the effective period of the content data has elapsed.

The user 450 makes payment b for September at the end of August. At the time of confirming the payment b, the subscription service server 401 renews the charging information and authorizes downloading by the user 450 of the deliverable contents until the end of September, based on the renewed charging information. The subscription service server 410 sets the effective period of the music data to be delivered, based on the renewed charging information. Specifically, the effective period of, for example, music data C downloaded after the payment b, is set at September 30. The subscription service server 401 sets the effective period by, for example, writing the effective period information to the music data.

When the charging information is renewed, the subscription service server 401 renews the effective period set in the music that has been downloaded. Specifically, the subscription service server 401 changes the effective period of, for example, the music data A and the music data B downloaded prior to the confirmation of the payment b, to September 30. The subscription service server 401 transmits, for example, renewal authentication information with the renewed effective period described therein to the content reproducing apparatus 410 by way of the network 420. When the content reproducing apparatus 410 does not have a communication function, the content reproducing apparatus 410 acquires the renewal authentication information by way of another terminal device having a communication function. The content reproducing apparatus 410 upon receipt of transmission of the renewal authentication information rewrites the effective period information written in the music data to the renewed effective period described in the renewal authentication information, thereby enabling the music data to be reproduced through the renewed effective period.

The renewal authentication information is transmitted to the content reproducing apparatus 410 by way of the network 420. Therefore, when the content reproducing apparatus 410 cannot to use the network 420, the renewal authentication information cannot be received. For example, when the user 450 is out of his home, abroad on a trip, or on a business trip, for a long period, the user 450 may not be able to connect with the network 420 that the user 450 is authorized to use. When the content reproducing apparatus 410 is the navigation device 410a and is located in mountains, connection with the network 420 may not be possible. In such case, the content reproducing apparatus 410 cannot extend the effective period and cannot reproduce the content data despite payment of the fee.

To prevent such a situation, at the time of confirming the payment from the user 450 of the content reproducing apparatus 410, the subscription service server 401 sends the temporary authentication information to temporarily extend the effective period of the content data to the user 450 without using the network 420. The temporary authentication information includes, for example, the permit information to permit the reproduction of the content data only for a predetermined period, a program capable of executing the reproduction of the content data only for the predetermined period, etc.

The temporary authentication information is generated based on information that can be known commonly to the subscription service server 401 and the content reproducing apparatus 410 even if the subscription service server 401 and content reproducing apparatus 410 are unable to communicate by way of the network 420, such as the identification information that identifies the content reproducing apparatus 410 or the user 450. The temporary authentication information is generated by a generating method (logic) that can be known only to the subscription service server 401 and the content reproducing apparatus 410 and cannot be known to the user 450. Specifically, there are methods such as, for example, a method of rearranging a certain character string according to a predetermined logic and treating such rearranged string as the temporary authentication information.

As described, the subscription service server 401 and the content reproducing apparatus 410 have in common information from which the temporary authentication information is generated and the method of generation thereof. For this reason, the content reproducing apparatus 410 can generate the same information as the temporary authentication information sent by the subscription service server 401 and can confirm whether the temporary authentication information acquired by the content reproducing apparatus 410 has been officially issued (is not fraudulently created by the user 450).

The temporary authentication information is sent by displaying the information on a display unit of, for example, equipment used by the user 450 in making payment of the monthly charge (such as a cash dispenser used in a bank-to-bank transfer, a POS terminal used in payment at a convenience store, and a cellular phone terminal device used in mobile banking). In this case, the user 140 reads the temporary authentication information displayed on the display unit and inputs the information to the content reproducing apparatus 410.

The temporary authentication information may also be sent, for example, by outputting the information to a receipt, etc., to be issued when the monthly charge is paid by the user 450. In this case, the user 450 reads the temporary authentication information output to the receipt and inputs the information to the content reproducing apparatus 410. The temporary authentication information may also be sent, for example, by sending a recording medium storing therein the temporary authentication information to the user 450. In this case, the user 450 causes the content reproducing apparatus 410 to read out the temporary authentication information stored in the recording medium.

The temporary authentication information may also be sent, for example, when the user 450 makes, by electronic mail or telephone, an inquiry concerning the temporary authentication information to an operator of the subscription service after the payment of the monthly charge. The temporary authentication information may also be transmitted to the content reproducing apparatus 410 when, for example, the temporary authentication information is of a low volume as compared with the renewal authentication information and may be transmitted by way of the network 420.

The period for which the effective period is extended by the temporary authentication information may be fixed or may be determined according to the payment amount transferred from the user 450. The temporary authentication information may be the information for rewriting the effective period information of each content data or may be information for controlling the reproducing function so that the content data can be reproduced only for the extended period, without rewriting the effective period information of each content data.

Further, configuration may be such that the user 450 can request by telephone, electronic mail, etc., the sending of additional temporary authentication information when, for example, the renewal authentication information cannot be received within the effective period extended by the temporary authentication information and formal renewal cannot be performed. In this case, the subscription service server 401 authenticates the user 450 who requested the additional temporary authentication information, confirms the charging information, and sends to the user 450 the additional temporary authentication information within the period corresponding to the monthly charge that has been paid.

When the renewal authentication information is received within the period extended by the temporary authentication information, the content reproducing apparatus 410 renews the effective period information of the content data and reproduces the content data based on the renewed effective period information.

As described, the subscription service server 401 issues the temporary authentication information at the time of payment of the monthly charge, thereby enabling the user to temporarily extend the effective period using the temporary authentication information and reproduce the content data.

Description with respect to FIG. 5 continues. The user 450 makes payment c for October at the end of September. At the time of confirmation of the payment c, the subscription service server 401 renews the charging information and authorizes the user 450 to download applicable contents through the end of October according to the renewed charging information. When the charging information is renewed, the subscription service server 401 renews the effective period set for the music that has been downloaded. Specifically, the subscription service server 401, for example, transmits the renewal authentication information to extend the effective period of the music data A, the music data B, and the music data C downloaded prior to the confirmation of the payment c to October 31 and at the same time, sends the temporary authentication information to temporarily extend the effective period.

Although the diagram depicted in FIG. 5 describes a method of payment by the monthly charge, the payment method is not limited hereto. Specifically, configuration may be such that the payment method is set by the operator, etc., who provides the subscription service, such as, for example, a payment method according to an annual charge that bills a one-year fee, annually.

While description has explained that in extending the effective period of the content data, the subscription service server 401 transmits the renewal authentication information to the content reproducing apparatus 410 and the content reproducing apparatus 410 rewrites the effective period information of the music data, the subscription service server 401 may also rewrite the effective period information of the music data directly.

### (Hardware Configuration of Subscription Service Server 401)

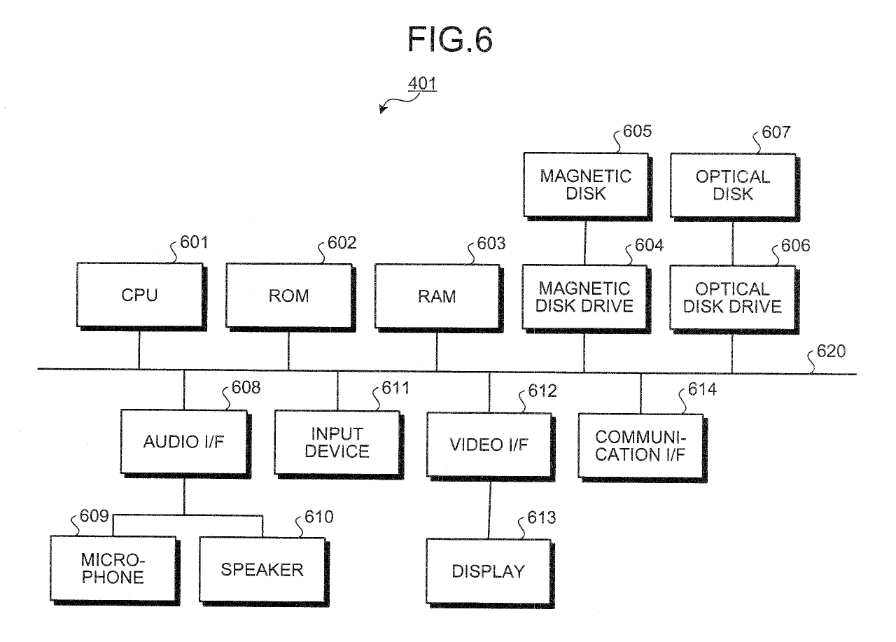

A hardware configuration of the subscription service server 401 according to the example will be described with reference to FIG. 6. FIG. 6 is a block diagram of one example of a hardware configuration of the subscription service server.

As depicted in FIG. 6, the subscription service server 401 includes a CPU 601, a ROM 602, a RAM 603, a magnetic disk drive 604, a magnetic disk 605, an optical disk drive 606, an optical disk 607, an audio I/F (interface) 608, a microphone 609, a speaker 610, an input device 611, a video I/F 612, a display 613, and a communication I/F 614, respectively connected through a bus 620.

The CPU 601 governs overall control of the subscription service server 401. The ROM 602 stores therein various programs such as a boot program, a communication program, a data managing program, and an effective period setting program. The RAM 603 is used as a work area of the CPU 601.

The magnetic disk drive 604 controls the reading and writing of data with respect to the magnetic disk 605 under the control of the CPU 601. The magnetic disk 605 records the data written under the control of the magnetic disk drive 604. The magnetic disk 605 may be HD (hard disk) or FD (flexible disk), for example.

The optical disk drive 606 controls the reading and writing of data with respect to the optical disk 607 under the control of the CPU 601. The optical disk 607 is a removable recording medium having data read out under the control of the optical disk drive 606. A writable recording medium may be utilized for the optical disk 607. The removable recording medium may be a medium other than the optical disk 607, such as an MO and a memory card.

The audio I/F 608 is connected to the microphone 609 and the speaker 610. The microphone 609 receives sound. The audio I/F 608 A/D converts sound, and the speaker 610 outputs sound.

The input device 611 includes a remote controller having keys for entering characters, numeric values, and various instructions; a keyboard; a mouse; a touch panel; etc.

The video I/F 612 is connected to the display 613. Specifically, the video I/F 612 includes, for example, a graphic controller that governs overall control of the display 613, a buffer memory such as VRAM (Video RAM) that temporarily records immediately displayable image information, and a control IC that controls the display 613 based on image data output from a graphic controller.

The display 613 displays icons, cursors, menus, windows, and/or various data such as characters and images. For example, a CRT, a TFT liquid crystal display, a plasma display, etc., may be employed as the display 613.

The communication I/F 614 is connected to the network 420 and functions as an interface between the network 420 and the CPU 601.

Respective functions of the payment information acquiring unit 111, the temporary authentication information sending unit 112, and the formal authentication information sending unit 113 provided in the content delivery apparatus 110 depicted in FIG. 1 are realize by the CPU 601 executing a predetermined program, using the program and the data recorded in the ROM 602, the RAM 603, the magnetic disk 605, the optical disk 607, etc., in the subscription service server 401 depicted in FIG. 6, and controlling each unit of the subscription service server 401.

The subscription service server 401 in the example is capable of executing the functions of the content delivery apparatus 110 depicted in FIG. 1 according to the content delivery procedure depicted in FIG. 2 by executing the content delivery program recorded in the ROM 602 as a recording medium in the subscription service server 401.

(Hardware Configuration of Navigation Device 410a)

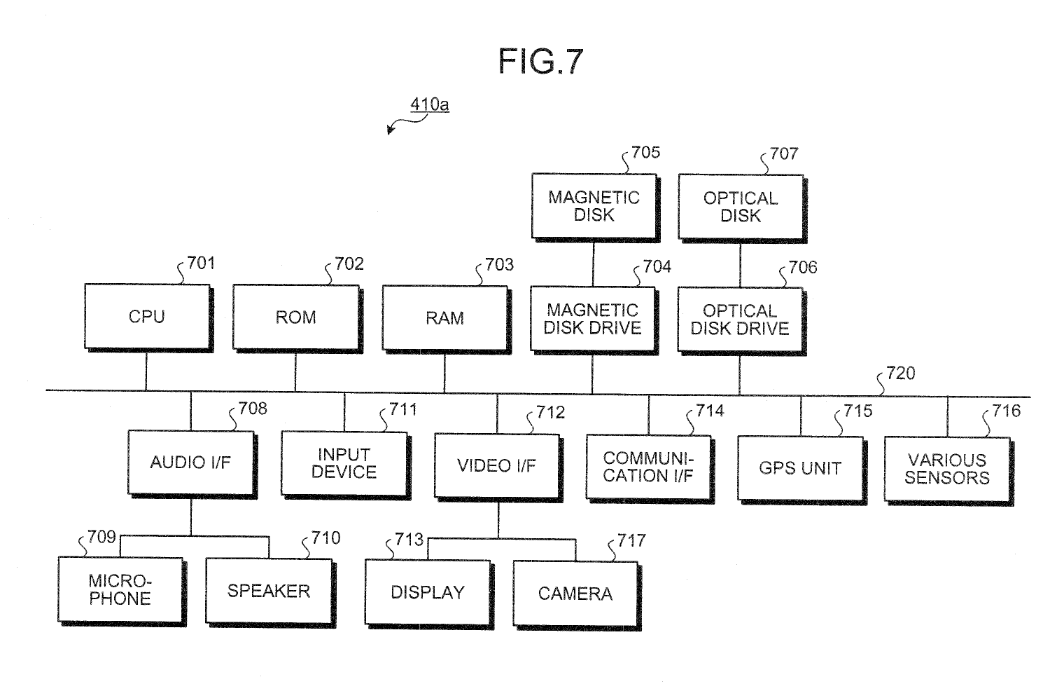

A hardware configuration of the navigation device 410a according to the example will be described with reference to FIG. 7. FIG. 7 is a block diagram of one example of a hardware configuration of the navigation device.

As depicted in FIG. 7, the navigation device 410a includes a CPU 701, a ROM 702, a RAM 703, a magnetic disk drive 704, a magnetic disk 705, an optical disk drive 706, an optical disk 707, an audio I/F (interface) 708, a microphone 709, a speaker 710, an input device 711, a video I/F 712, a display 713, and a communication I/F 714, a GPS unit 715, various sensors 716, and a camera 717, respectively connected through a bus 720.

The CPU 701 governs overall control of the navigation device 410a. The ROM 702 stores therein various programs such as a boot program, a route retrieval program, a route guidance program, a communication program, and a content reproduction program. The RAM 703 is used as a work area of the CPU 701.

The magnetic disk drive 704 controls the reading and writing of data with respect to the magnetic disk 705 under the control of the CPU 701. The magnetic disk 705 records the data written under the control of the magnetic disk drive 704. The magnetic disk 705 may be HD (hard disk) or FD (flexible disk), for example.

The optical disk drive 706 controls the reading and writing of data with respect to the optical disk 707 under the control of the CPU 701. The optical disk 707 is a removable recording medium having data read out under the control of the optical disk drive 706. A writable recording medium may be utilized for the optical disk 707. The removable recording medium may be a medium other than the optical disk 707, such as an MO and a memory card.

The audio I/F 708 is connected to the microphone 709 that is for inputting sound and the speaker 710 that is for outputting sound. The audio I/F 708 A/D converts sound. The speaker 710, outputs sound (specifically, music data reproduced by the content reproducing program).

The input device 711 includes a remote controller having keys for entering characters, numeric values, and various instructions; a keyboard; a mouse; a touch panel; etc.

The video I/F 712 is connected to the display 713. Specifically, the video I/F 712 includes, for example, a graphic controller that governs overall control of the display 713, a buffer memory such as VRAM (Video RAM) that temporarily records immediately displayable image information, and a control IC that controls the display 713 based on image data output from a graphic controller.

The display 713 displays icons, cursors, menus, windows, and/or various data such as characters and images. For example, a CRT, a TFT liquid crystal display, a plasma display, etc., may be employed as the display 713.

The communication I/F 714 is wirelessly connected to the network 420 (refer to FIG. 4) and functions as an interface between the network 420 and the CPU 701.

The GPS unit 715 receives signals from GPS satellites and outputs information indicative of the current position of the vehicle. The information output from the GPS unit 715 is used along with output values of the various sensors 716 described hereinafter when the CPU 701 calculates the current position of the vehicle. The information indicative of the current position is information specifying one point on map information, for example, latitude/longitude and altitude.

The various sensors 716 include a speed sensor, an acceleration sensor, and an angular-speed sensor and output information that enables vehicular position and behavior to be determined. Values output from the various sensors 716 are used by the CPU 701 for calculating the current position of the vehicle and measuring changes in velocity and direction.

The camera 717 records images inside or outside of a vehicle. The images may be either a still image or a moving image. Images recorded by the camera 717 are output to a recording medium such as the magnetic disk 705 or the optical disk 707 by way of the video I/F 712.

Respective functions of the formal authentication information acquiring unit 121, the input unit 122, the determining unit 123, the reproducing unit 124, the temporary authentication information acquiring unit 125, and the authenticating unit 126 provided in the content reproducing apparatus 120 depicted in FIG. 1 are realized by the CPU 701 executing a predetermined program, using the program and the data recorded in the ROM 702, the RAM 703, the magnetic disk 705, the optical disk 707, etc., in the navigation device 410a depicted in FIG. 7, and controlling each unit of the navigation device 410a.

The navigation device 410a of the example is capable of executing the functions of the content reproducing apparatus 120 depicted in FIG. 1 according to the content reproducing procedure depicted in FIG. 3 by executing the content reproducing program recorded in the ROM 702 as a recording medium in the navigation device 410a.

### (Effective Period Renewal Processing by Subscription Service Server)

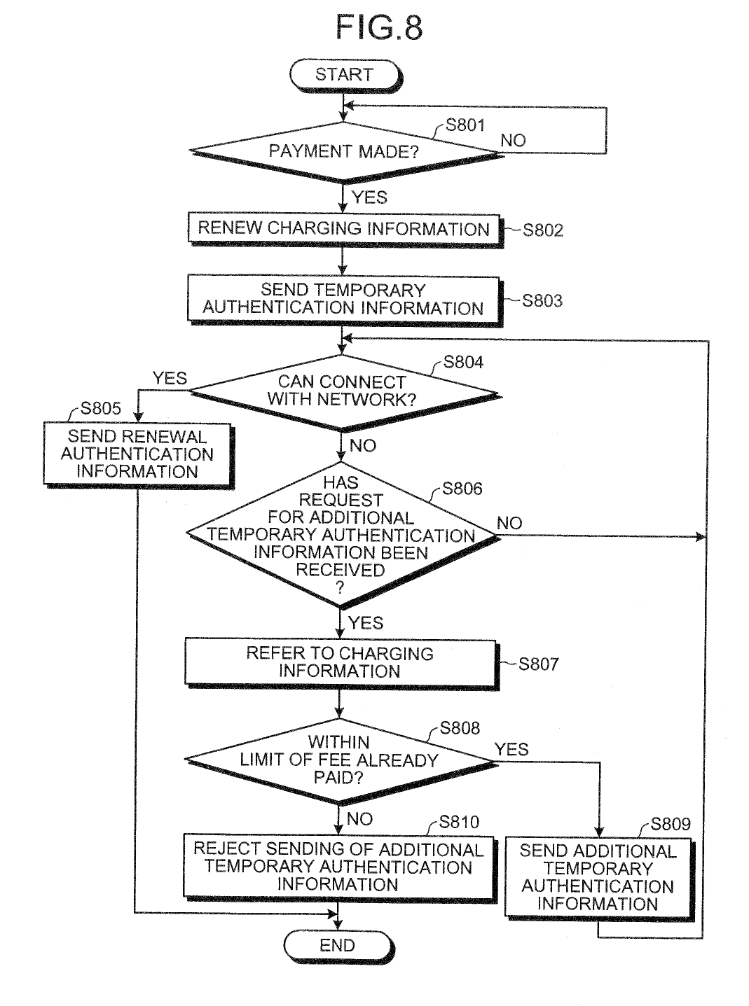

Effective period renewal processing of the music data by the subscription service server 401 will be described with reference to FIG. 8. As described above, the subscription service server 401 renews the effective period according to the payment of the monthly charge from the user 450. Details will be described of the processing in such case. It is assumed that prior to this processing, the subscription service server 401 has delivered music data to the content reproducing apparatus 410 of the user 450 in response to a request from the user 450. The music data consequently delivered at that time has the effective period information already written therein.

FIG. 8 is a flowchart of a procedure of effective period renewal processing by the subscription service server As depicted in the flowchart of FIG. 8, the subscription service server 401 waits until the monthly charge is paid by the user 450 for the subscription service (step S801: NO). When the monthly charge is paid (step S801: YES), the subscription service server 401 renews the charging information for the user 450 (step S802).

The subscription service server 401 then sends the temporary authentication information to temporarily extend the effective period of the music data to the user 450 (step S803). The subscription service server 401 determines whether the content reproducing apparatus 410 of the user 450 can connect to the network 420 (step S804). If the content reproducing apparatus 410 can connect to the network 420 (step S804: YES), the subscription service server 401 transmits the renewal authentication information to the content reproducing apparatus 410 (step S805) and the processing according to this flowchart ends.

Without use of the determination process at step S804, the content reproducing apparatus 410 may be deemed to be able to connect with the network 420, for example, when the renewal authentication information is transmitted (see step S805) and the renewal authentication information is received (or is not sent back as a transmission error) by the content reproducing apparatus 410.

On the other hand, when the content reproducing apparatus 410 cannot connect to the network 420 (step S804: NO), the subscription service server 401 determines whether the request for the additional temporary authentication information has been received from the user 450 (step S806). If the request for the additional temporary authentication information has not been received (step S806: NO), the subscription service server 401 returns to step S804 and continues subsequent processing.

On the other hand, if the request for the additional temporary authentication information has been received (step S806: YES), the subscription service server 401 refers to the charging information corresponding to the user 450 (step S807) and determines whether the received request for additional temporary authentication information is within the limit of the monthly charge paid at step S801 (already paid charge) (step S808). If the received request is within the limit of the already paid charge (step S808: YES), the subscription service server 401 sends the additional temporary authentication information to the user 450 (step S809), returns to step S804, and continues subsequent processing. On the other hand, if the received request is not within the limit of the already paid charge (step S808: NO), then the subscription service server 401 rejects sending of additional temporary authentication information (step S810) and the processing according to this flowchart ends.

### (Content Reproduction Processing by the Content Reproducing Apparatus 410)

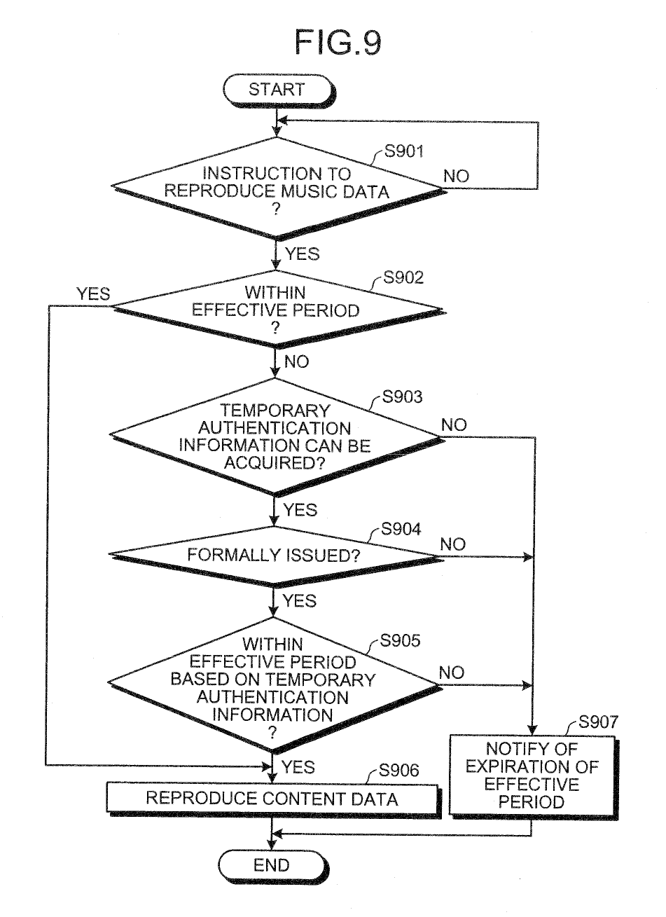

The content reproduction processing by the content reproducing apparatus 410 will be described with reference to FIG. 9. FIG. 9 is a flowchart of a procedure of the content reproduction processing by the content reproducing apparatus. It is assumed that prior to this processing, music data has been delivered from the subscription service server 401 to the content reproducing apparatus 410. The music data delivered at that time has the effective period information already written therein.

As depicted in the flowchart of FIG. 9, the content reproducing apparatus 410 waits until an instruction to reproduce the music data is given by the user 450 (step S901: NO). The instruction to reproduce the music data is given, for example, by the user 450 selecting desired music data from among the music data recorded in the content reproducing apparatus 410 by way of the input device 711.

If an instruction is given to reproduce the music data (step S901: YES), the content reproducing apparatus 410 refers to the effective period information of the selected music data and determines whether the present time is within the effective period of the music data (step S902). When, for example, a time is specified for starting the reproduction of the music data, such as in a case of reserved reproduction, the content reproducing apparatus 410 may also determine whether the time specified for starting the reproduction is within the effective period.

If the time is within the effective period of the music data, the reproduction of which is instructed (step S902: YES), and the content reproducing apparatus 410 proceeds to step S906. On the other hand, if it is not within the effective period of the music data (step S902: NO), the content reproducing apparatus 410 determines whether the temporary authentication information can be acquired (step S903). Whether the temporary authentication information can be acquired is determined, for example, by the content reproducing apparatus 410 requesting the user 450 to input the temporary authentication information, determining whether the temporary authentication information has been input by the user 450 in response to such request.

If the temporary authentication information can be acquired (step S903: YES), the content reproducing apparatus 410 determines whether the acquired temporary authentication information is information officially issued by the subscription service server 401 (step S904). As described above, the content reproducing apparatus 410 and the subscription service server 401 have in common the information from which the temporary authentication information is generated and the method of generation thereof Thus, the content reproducing apparatus 410 can generate the same information as the temporary authentication information sent by the subscription service server 401 and can confirm whether the temporary authentication information acquired by the content reproducing apparatus 410 has been officially issued (is not fraudulently created by the user 450, etc.).

If the temporary authentication information has been officially issued by the subscription service server 401 (step S904: YES), the content reproducing apparatus 410 determines whether the present time is within the effective period, based on the temporary authentication information (step S905). As at step S902, when a time is specified for starting the reproduction of the music data, the content reproducing apparatus 410 may also determine whether the time specified for starting the reproduction is within the effective period.

If the present time is within the effective period based on the temporary authentication information (step S905: YES) or if, at step S902, the present time is within the effective period of the content data (within the effective period based on the effective period information) (step S902), then the content reproducing apparatus 410 reproduces the content data (step S906) and processing according to the flowchart ends.

On the other hand, if the present time is not within the effective period, based on the temporary authentication information (step S905: NO), then the content reproducing apparatus 410 notifies the user 450 of expiration of the effective period of the content data (step S907) and processing according to the flowchart ends. In this case, the user 450, for example, requests the additional temporary authentication information, etc., from the subscription service server 401.

The content reproducing apparatus 410 notifies the user 450 of expiration of the effective period of the content data (step S907) and finishes the processing according to the flowchart also when the temporary authentication information cannot be acquired at step S903 (step S903: NO) and when the temporary authentication information is not officially issued by the subscription service server 401 at step S904 (step S904: NO).

As described above, the music delivery system 400 sends temporary authentication information to temporarily extend the effective period of content data, to the user 450 simultaneously upon completion of the payment of the monthly charge. The user 450 can temporarily extend the effective period and reproduce the music data by inputting the temporary authentication information to the content reproducing apparatus 410 even if the content reproducing apparatus 410 cannot connect to the network 420 and cannot formally renew the effective period, thereby preventing a situation in which the music data can no longer be reproduced despite payment of the monthly charge by the user 450 and improving the convenience of the music delivery system 400.

With the information from which the temporary authentication information is generated and the method of generation thereof being shared by the subscription service server 401 and the content reproducing apparatus 410, the content reproducing apparatus 410 can confirm whether the temporary authentication information has been officially issued (is not fraudulently created by the user 450, etc.), thereby enabling the music delivery system 400 to securely obtain the fee for the delivery of the content data while maintaining its convenience.

The content delivery method, the content reproduction method explained in the present embodiment can be implemented by a computer, such as a personal computer and a workstation, executing a program that is prepared in advance. The program is recorded on a computer-readable recording medium such as a hard disk, a flexible disk, a CD-ROM, an MO, and a DVD, and is executed by being read out from the recording medium by a computer. The program can be distributed through a network such as the Internet.

1-8. (canceled)

9. A content delivery apparatus that delivers, to an information processing device, content data reproducible within an effective period, the content delivery apparatus comprising:
a payment information acquiring unit that acquires information concerning a state of payment that is from a user of the information processing device and for a fee for delivery of the content data;
a temporary authentication information sending unit that sends, to the user without using a communication line, temporary authentication information to temporarily extend the effective period, when the information acquired by the payment information acquiring unit indicates that the payment of the fee has been made; and
a formal authentication information sending unit that sends, to the information processing device by using the communication line, formal authentication information to formally extend the effective period, when the information acquired by the payment information acquiring unit indicates that the payment of the fee has been made.

10. A content reproducing apparatus that reproduces content data reproducible within an effective period, the content reproducing apparatus comprising:
a formal authentication information acquiring unit that acquires, by using a communication line and from a content delivery apparatus that delivers the content data, formal authentication information to extend the effective period;
an input unit that receives input of an instruction to reproduce the content data;
a determining unit that determines whether a date and time at which the input unit receives the instruction to reproduce is within the effective period based on the formal authentication information acquired by the formal authentication information acquiring unit;
a reproducing unit that reproduces the content data when the determining unit determines that the date and time are within the effective period based on the formal authentication information; and
a temporary authentication information acquiring unit that, without using a communication line, acquires temporary authentication information to temporarily extend the effective period, when the determining unit determines that the date and time are not within the effective period based on the formal authentication information, wherein
the determining unit determines whether the date and time at which the input unit receives the instruction to reproduce are within the effective period based on the temporary authentication information acquired by the temporary authentication information acquiring unit, and
the reproducing unit reproduces the content data, when the determining unit determines that the date and time are within the effective period based on the temporary authentication information.

11. The content reproducing apparatus according to claim 10, further comprising:
an authenticating unit that authenticates whether the temporary authentication information acquired by the temporary authentication information acquiring unit is the information sent by the content delivery apparatus, wherein
the determining unit determines whether the date and time at which the input unit receives the instruction to reproduce is within the effective period based on the temporary authentication information acquired by the temporary authentication information acquiring unit, when the authenticating unit authenticates that the temporary authentication information is the information sent by the content delivery apparatus.

12. A content delivery method of delivering, to an information processing device, content data reproducible within an effective period, the content delivery method comprising:
acquiring information concerning a state of payment that is from a user of the information processing device and for a fee for delivery of the content data;
sending, to the user without using a communication line, temporary authentication information to temporarily extend the effective period, when the information acquired at the acquiring indicates that the payment of the fee has been made; and
sending, to the information processing device by using the communication line, formal authentication information to formally extend the effective period, when the information acquired at the acquiring indicates that the payment of the fee has been made.

13. A content reproducing method of reproducing content data reproducible within an effective period, the content reproducing method comprising:
acquiring, by using a communication line and from a content delivery apparatus that delivers the content data, formal authentication information to extend the effective period;
receiving input of an instruction to reproduce the content data;
determining whether a date and time at which the instruction to reproduce is received at the receiving are within the effective period based on the formal authentication information acquired at the acquiring;
reproducing the content data when at the determining it is determined that the date and time are within the effective period based on the formal authentication information;
acquiring, without using a communication line, temporary authentication information to temporarily extend the effective period, when at the determining it is determined that the date and time are not within the effective period based on the formal authentication information;
determining whether the date and time at which the instruction to reproduce is received at the receiving are within the effective period based on the temporary authentication information acquired at the acquiring the temporary authentication information; and
reproducing the content data, when at the determining whether the date and time are within the effective period based on the temporary authentication information, it is determined that the date and time are within the effective period based on the temporary authentication information.

14. A computer-readable recording medium storing therein a content delivery program for delivering, to an information processing device, content data reproducible within an effective period, the content delivery program causing a computer to execute:
acquiring information concerning a state of payment that is from a user of the information processing device and for a fee for delivery of the content data;
sending, to the user without using a communication line, temporary authentication information to temporarily extend the effective period, when the information acquired at the acquiring indicates that the payment of the fee has been made; and
sending, to the information processing device by using the communication line, formal authentication information to formally extend the effective period, when the information acquired at the acquiring indicates that the payment of the fee has been made.

15. A computer-readable recording medium storing therein a content reproduction program for reproducing content data reproducible within an effective period, the content reproduction program causing a computer to execute:
acquiring, by using a communication line and from a content delivery apparatus that delivers the content data, formal authentication information to extend the effective period;
receiving input of an instruction to reproduce the content data;
determining whether a date and time at which the instruction to reproduce is received at the receiving are within the effective period based on the formal authentication information acquired at the acquiring;
reproducing the content data when at the determining it is determined that the date and time are within the effective period based on the formal authentication information;
acquiring, without using a communication line, temporary authentication information to temporarily extend the effective period, when at the determining it is determined that the date and time are not within the effective period based on the formal authentication information;
determining whether the date and time at which the instruction to reproduce is received at the receiving are within the effective period based on the temporary authentication information acquired at the acquiring the temporary authentication information; and
reproducing the content data, when at the determining whether the date and time are within the effective period based on the temporary authentication information, it is determined that the date and time are within the effective period based on the temporary authentication information.
